(19) United States
(12) Patent Application Publication
(10) Pub. No.: US 2025/0190989 A1
(43) Pub. Date: Jun. 12, 2025

(54) AUTHORIZATION SYSTEM FOR TRANSACTION HOLD REMOVAL

(71) Applicant: The PNC Financial Service Group, Inc., Pittburgh, PA (US)

(72) Inventor: Robert E. Porco, New Kensington, PA (US)

(21) Appl. No.: 18/532,582

(22) Filed: Dec. 7, 2023

(51) Int. Cl. G06Q 20/40

(52) U.S. Cl. CPC G06Q 20/40145

(57) ABSTRACT

Disclosed is a method for authorizing a transaction hold renewal. The method including receiving a request to place a transaction hold on a financial account managed by a financial institution, updating a transaction hold status in an account information database from an inactive status to an active status in response to the received request, and receiving, from a requesting party, a subsequent request to remove the transaction hold. The method further includes receiving, from an employee of the financial institution, an input to update the transaction hold status from the active status to the inactive status, determining, by a computer system, an identity of the employee, confirming, by the computer system, an authority of the employee to remove the transaction hold by comparing the employee identity to an authorized employee list stored in a bank entitlements database, and removing the transaction hold based on the confirmed authority of the employee.

### BACKGROUND

Custodians of a financial account, such as a bank account or a credit card account, may wish to restrict, or otherwise limit, a use of such account in instances where account access information and/or a card, such as a debit card or credit card, for example, has been compromised, misplaced, and/or stolen. In an effort to prevent unauthorized transactions from occurring within the account, an account custodian may restrict the use of the associated account by freezing, or otherwise placing a hold, on account transactions.

An account custodian can halt transactions on a particular account with general ease and through multiple avenues. For example, the account custodian can submit a request for all transactions associated with the particular account to be halted, or otherwise prevented, by sending a message to a financial institution, by pressing a button within an application or on a website associated with the financial institution, and/or by calling an appropriate department within the financial institution, for example. The financial institution may only require the account custodian to provide an account identifier and/or other suitable credential in order to place a hold on the account. The necessary security surrounding “freezing” an account is minimal given the low risk level associated with such an activity. Stated another way, the contents of the financial account are not at risk of fraudulently disappearing and/or appearing by placing a hold on the account.

Conversely, the act of “unfreezing” a financial account carries significant risk. For example, if a fraudulent entity, or other unauthorized user, is successful in removing the transaction hold from a financial account, the fraudulent entity is capable of moving the contents of the financial account, often before or without the account custodian's knowledge. Existing systems treat a removal of the transaction hold in the same manner as an institution of the transaction hold. Such systems enable an unauthorized user to remove such a transaction hold merely by gaining access to an account custodian's password, for example. Enhanced security measures for preventing an unauthorized user from removing a transaction hold are disclosed herein.

### SUMMARY

In one general aspect, the present disclosure is directed to a method for authorizing a transaction hold renewal. The method including receiving a request to place a transaction hold on a financial account managed by a financial institution, updating an transaction hold status in an account information database from an inactive status to an active status in response to the received request to place the transaction hold on the financial account, and receiving, from a requesting party, a subsequent request to remove the transaction hold from the financial account. The method further including receiving, from an employee of the financial institution, an input to update the transaction hold status from the active status to the inactive status, determining, by a computer system, an identity of the employee, confirming, by the computer system, an authority of the employee to remove the transaction hold by comparing the determined employee identity to an authorized employee list stored in a bank entitlements database, and removing the transaction hold from the financial account based on the confirmed authority of the employee to remove the transaction hold.

In another general aspect, the present disclosure is directed to an authorization system for deactivating a transaction hold. The authorization system comprises a financial account comprising a transaction hold associated therewith and an account database comprising information relating to the financial account stored therein. The information comprises a status of the transaction hold, wherein the status of the transaction hold indicates whether the transaction hold is active or inactive. The transaction hold is to prevent a transaction from being completed while the transaction hold is active. The transaction hold is to permit the transaction from being completed while the transaction hold is inactive. The authorization system further comprises a graphical user interface to receive a first input from a user, wherein the first input is indicative of a request to transition the transaction hold from an active transaction hold to an inactive transaction hold and a processor to communicate with the account database and the graphical user interface. The processor is to receive the first input from the graphical user interface, determine an identity of the user, confirm the determined identity of the user corresponds to an authorized user by comparing the determined employee identity to the authorized employee list stored in the bank entitlements database, and update the status of the transaction hold in the account database from the active transaction hold to the inactive transaction hold based on the confirmation that the identity of the user corresponds to an authorized user.

In yet another general aspect, the present disclosure is directed to a method for authorizing a transaction hold renewal. The method including electronically receiving, from an employee of the financial institution, an input to update a transaction hold status from an active status to an inactive status, determining, by a computer system, an identity of the employee, and confirming, by the computer system, an authority of the employee to remove the transaction hold by comparing the determined employee identity to an authorized employee list stored in a bank entitlements database. The method further including removing, by the computer system, the transaction hold from the financial account based on the confirmed authority of the employee to remove the transaction hold and permitting, by the computer system, a transaction to be completed based on the removal of the transaction hold from the financial account.

### BRIEF DESCRIPTION OF THE FIGURES

Various embodiments of the present invention are described herein by way of example in connection with the following figures.

FIG. 1 is a schematic representing an example embodiment of a financial institution.

FIG. 2 is a schematic representing the example embodiment of the financial institution of FIG. 1 in greater detail.

FIG. 3 is an example embodiment of a process for removing a hold placed on a financial account.

FIG. 4 is an example embodiment of a process for removing a hold placed on a financial account by an employee of a financial institution.

Corresponding reference characters indicate corresponding parts throughout the several views. The exemplifications set out herein illustrate various disclosed embodiments, is one form, and such exemplifications are not to be construed as limiting the scope thereof in any manner.

### DETAILED DESCRIPTION

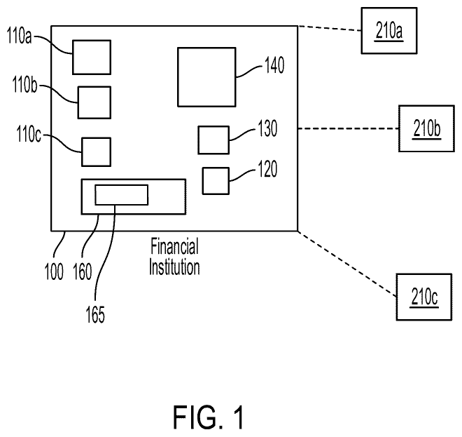

The schematic shown in FIG. 1 represents a framework of a financial institution 100. The financial institution 100 holds, or is otherwise responsible for, financial accounts 110a, 110b, 110c. Although three financial accounts 110a, 110b, 110c are depicted in FIG. 1, the reader will appreciate these three accounts are exemplary; the financial institution 100 can hold a different number of financial accounts.

Each particular financial account 110a, 110b, 110c is associated with, or is otherwise owned by, a particular account custodian 210a, 210b, 210c, respectively. Account custodians 210a, 210b, 210c possess unique identifiers, such as account numbers, usernames, and/or passwords, associated with their respective financial account 110a, 110b, 110c to assist in the management thereof. The account custodians 210a, 210b, 210c utilize one or more of the unique identifiers to gain access to the contents of their respective financial account 110a, 110b, 110c and initiate and/or complete transactions with such account contents. In certain instances, more than one account custodian can be associated with a financial account and/or an account custodian can be associated with more than one financial account at the financial institution 100.

In an effort to effectively support, sponsor, and/or manage the financial accounts 110a, 110b, 110c of the account custodians 210a, 210b, 210c, the financial institution 100 includes various departments or divisions of employees 120, 130, 140. Such departments can include, for example, a customer support department 120, a wealth management department 130, and a risk management department 140. In various instances, the customer support department 120 exists as the account custodian-facing department. Stated another way, employees from the customer support department 120 are the first point of contact for an account custodian and serve to direct the account custodian to an appropriate department to address a particular concern. In various instances, the wealth management department 130 exists for the purpose of growing the contents of the financial accounts 110a, 110b, 110c. Stated another way, employees from the wealth management department 130 have a hands-on involvement with the contents of financial accounts 110a, 110b, 110c. In various instances, the risk management department 140 exists to manage risks surrounding the contents of the financial accounts 110a, 110b, 110c. Stated another way, employees in the risk management department 140 assist in gaining access to a particular financial account and/or managing the transactions of the financial accounts.

While the purpose of all of the departments 120, 130, 140 revolve around the financial accounts 110a, 110b, 110c, the tasks and information needed to complete such tasks varies across the departments 120, 130, 140. For example, employees from the customer support department 120 do not necessarily need access to information about the particular contents of a financial account in order to assist an account custodian reset a password, whereas employees from the wealth management department 130 require such assess to make an informed decision regarding a potential investment opportunity.

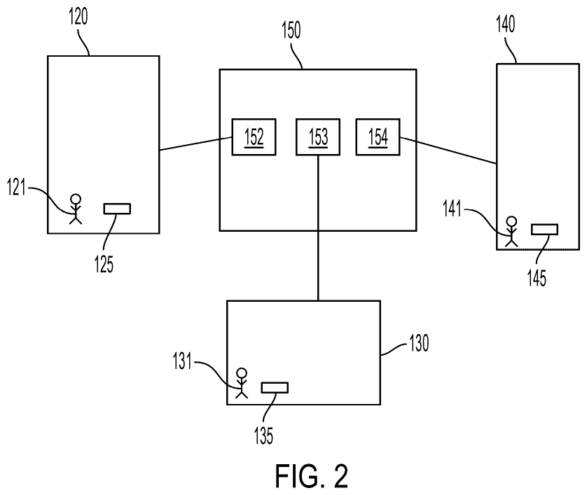

Given the highly valuable information associated with the financial accounts and stored by the financial institution, it is desirable for the financial institution to minimize access to parts, or all, of information unnecessary for a particular employee to know. Stated another way, the financial institution 100 benefits from limiting the number and/or identity of employees that have access to at least certain types of information associated with a financial account. As shown in FIG. 2, the financial institution 100 can grant and limit access to account information based on each particular employee's needs or credentials, for example. Credentials can be determined based on the employee's assigned-department, role, title, experience and/or background.

The financial institution 100 depicted in FIG. 1 further comprises one or more processors 160 (e.g., microprocessor, microcontroller) coupled to at least one memory circuit 165. The memory circuit 165 stores machine executable instructions that when executed by the one or more processors 160, cause the one or more processors 160 to execute machine instructions to implement various processes described herein. The one or more processors 160 may be any one of a number of single or multi-core processors known in the art. The memory circuit 165 may comprise volatile and nonvolatile storage media. The one or more processors 160 may include an instruction processing unit and an arithmetic unit. The instruction processing unit may be configured to receive instructions from the memory circuit 165. The one or more processors 160 are in communication with an account information database as described in greater detail herein to store various information associated with the financial accounts 110a, 110b, 110c and/or their associated account custodians 210a, 210b, 210c. The one or more processors 160 are further in communication with a bank entitlements database as described in greater detail herein to store various information associated with the credentials and/or accesses provided to employees of the financial institution.

As shown in FIG. 2, a first employee 121 working in the customer support department 120 is associated with a first credential 125. Such first credential 125 is recognizable by the processor 160 to grant the first employee 121 access to first account information 152 deemed necessary for the first employee 121 to do his or her job. For example, the first account information 152 can include a portion of an account number, a name of the account custodian, and/or other identifying information to be used in verifying an identity of an inquiring customer. Using such a first credential 125, the processor 160 limits the first employee's access to other information 153, 154 associated with the financial account 150, such as complete account numbers, account passwords, and/or account transactions. Limiting access of the first employee 121 to such additional information 153, 154 minimizes the risk of such information becoming compromised and/or leaked to an unauthorized user.

Similarly, a second employee 131 working in the wealth management department 130 is associated with a second credential 135. Such second credential 135 is recognizable by the processor 160 to grant the second employee 131 access to second account information 153 deemed necessary for the second employee 131 to do his or her job. For example, the second account information 153 can include investment information regarding the contents of the financial account 150 including balances and transactions. Such second credential 135 is used by the processor 160 to limit the second employee's access to other information 152, 154 associated with the financial account 150, such as complete account numbers and/or account passwords, for example. Limiting access of the second employee 131 to such additional information 152, 154 minimizes the risk of such information becoming compromised and/or leaked to an unauthorized user.

In various instances, the second employee 131 can have access to both the first information 152 and the second information 153, but not additional information 154. Stated another way, the second employee 131 may be entitled to additionally access the information 152 made available to the first employee 121. Such additional access can be granted to the second employee 131 by the financial institution 100 after one or more background checks on the second employee 131 are cleared, for example.

A third employee 141 working in the risk management department 140 is associated with a third credential 145. Such third credential 145 is recognizable by the processor 160 to grant the third employee 141 access to third account information 154 deemed necessary for the third employee 141 to do his or her job. For example, access to the third account information 154 can permit the third employee 141 to cancel, pause, or otherwise prevent a particular transaction associated with the financial account 150 or to, for a period of time, “freeze” a financial account 150. In other instances, access to the third account information 154 permits the third employee 141 to “unfreeze” a financial account 150 to permit transactions to once again be completed, or otherwise initiated. Recognition of such third credential 145 may cause the processor 160 to limit the third employee's access to other information 152, 153 associated with the financial account 150, such as account custodian identifiers and/or account numbers, for example. Limiting access of the third employee 141 to such additional information 152, 153 minimizes the risk of such information becoming compromised and/or leaked to an unauthorized user.

In various instances, the third employee 141 can have access to all of the information 152, 153, 154 associated with the financial account 150. Such additional access can be granted to the third employee 141 by the financial institution 100 after one or more background checks on the third employee 141 are cleared, for example. The financial institution 100 can adjust its risk of information becoming compromised and/or leaked to an unauthorized user by granting additional employees access to such information or limiting access to fewer employees. An assessment of desirable risk can be performed and ultimate employee access can be based on the type of information involved, for example.

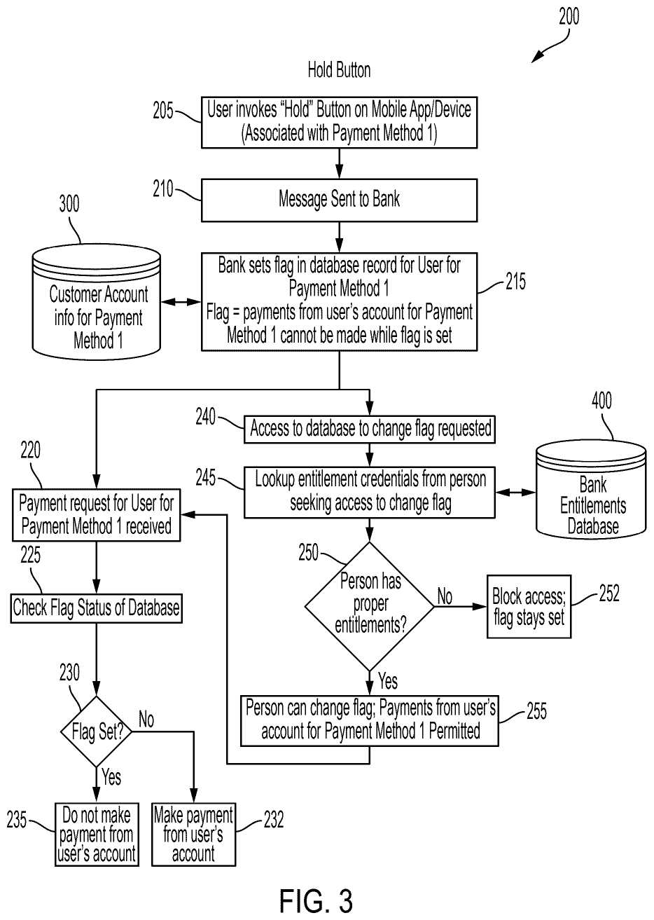

FIG. 3 depicts a process 200 for removing a hold placed on a financial account by a user. The process 200 can be implemented by the financial institution 100 (FIG. 1) and/or can be applied to the financial accounts 110a, 110b, 110c (FIG. 1) and/or the financial account 150 (FIG. 2), for example. Referring primarily to FIG. 3, a user (e.g. one of the account custodians 210a, 210b, 210c in FIG. 1) initiates 205 a hold on a financial account by pressing, or otherwise selecting, a button within an application or on a website associated with the financial institution, for example. While the user is described as initiating a hold on a financial account by selecting a button within a digital application or a website, it is envisioned that the user can initiate the hold by calling the financial institution, sending a written communication to the financial institution, calling the financial institution, and/or communicating the request to the financial institution in any suitable manner. Such a user input causes a message to be sent 210 to the processor 160 of the financial institution 100 to prevent any pending or future transactions associated with the financial account from being completed. Upon receiving the message resulting from the user input, the processor sets 215 a flag in a database 300 to prevent a transaction involving moving contents out of the flagged financial account from occurring. The flag comprises an electronic flag and corresponds to a hold being placed on, or a “freezing” of, the financial account. In various instances, all transactions, including those involving moving contents into the flagged financial account, are prevented from being initiated and/or completed.

While the depicted process is intended to be performed with a computer processor, manual, operator intervention is envisioned as necessary to facilitate and/or advance the process. For example, such an electronic flag can be manually set based on, or in response to, the message being sent 210 to the financial institution. In other instances, the electronic flag can be set without manual intervention by an algorithm in response to a processor of the financial institution receiving the message resulting from the user input. The processor 160 of the financial institution can comprise servers, for example, which may be remote from the financial institution. The processor 160 can communicate with a secure database 300 that includes information associated with the particular financial account including, an identity of an account custodian, account numbers, usernames, passwords, and/or any other information associated with the financial account.

In various instances, the processor 160 receives 220 a request for a transaction to be initiated and/or completed for a particular financial account. Prior to initiating such request, the processor 160 is to confirm 225 that a flag has not been set on the financial account. Such confirmation can be completed by analyzing 230 the contents of the account database 300. In instances where the processor determines that a flag has not been set on the financial account, the processor approves the request by permitting 232 the transaction to occur. Such transaction can involve, for example, payment of funds from the financial account. In instances where the processor determines that a flag has been set, or cannot determine whether or not a flag has been set, on the financial account, the processor denies, or otherwise prevents 235, the transaction from occurring.

In various instances, a request 240 to modify information stored in the account database 300 is submitted and received by the processor 160. For example, the request is to modify a flag status to remove the current flag associated with the financial account. Upon receiving the request to modify information stored in the account database 300, the processor reviews 245 a credential of the requesting party to confirm the requesting party is entitled to change the flag status. Such confirmation can be completed by obtaining 250 data in a bank entitlements database 400, for example, to determine if the requesting party has the proper entitlements. Confirmation includes confirming an identity of the requesting party as an employee of the financial institution and that the identified employee is credentialed, or otherwise entitled, to modify flag states of the particular financial account. The identity of the requesting party can be confirmed with one or more security features including passwords and/or two- or more-step authentication. The bank entitlements database 400 stores information regarding which employees (e.g. employees 121, 131, 141 in FIG. 2) have access to particular account information (e.g. account information 152, 153, 154 in FIG. 2) based on the employee's credentials (e.g. credentials 125, 135, 145 in FIG. 2). In various instances, the bank entitlements database 400 can store a list of credentialed employees who are authorized to remove account hold flags from financial accounts.

As discussed herein, not all employees of the financial institution are entitled to perform certain acts and/or are entitled to certain information. In instances where the processor determines that the requesting party is not an employee, is an employee not entitled to modify the flag status of the financial account, and/or cannot otherwise determine an identity of the requesting party, the processor maintains 252 the current flag status and blocks access to the account database 300. Depending on the determined identity of the requesting party, the processor can block all access to the account database 300 or partial access to the account database 300. In instances where partial access to the account database 300 is permitted, the requesting party can access, or read, information within the account database 300 but cannot modify, or write, such information stored therein, for example. In instances where the processor determines that the requesting party is an employee with the appropriate credentials, the processor modifies 255 the current flag status, thereby removing the flag associated with the financial account in the account database 300. As such, when the processor receives 220 a request for a transaction to be initiated and/or completed, the processor will permit 232 the transaction to occur.

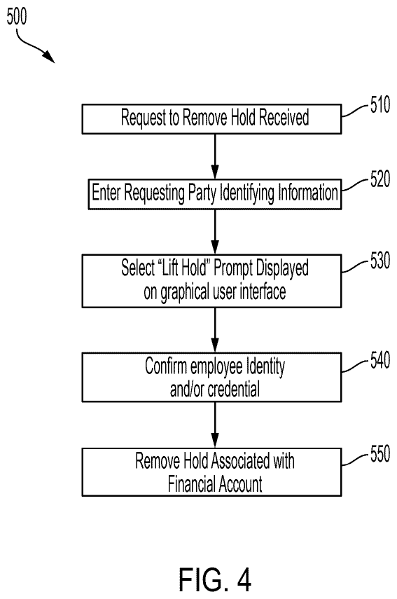

In various instances, an identity of an employee, or party, requesting access to modify (e.g. modification 255 in FIG. 3) a flag setting of a financial account (financial accounts 110a, 110b, 110c (FIG. 1) and/or the financial account 150 (FIG. 2)) can be confirmed prior to removing a hold on a financial account. A process 500 for removing such a hold is shown in FIG. 4. As discussed herein, a user, or account custodian can request for an account hold to be removed thereby permitting transactions to be initiated and completed. Such a request is received 510 by an employee (e.g. employee 121, 131, 141 in FIG. 2) of the financial institution. In various instances, a graphical user interface (GUI) such as a tablet, a computer, and/or other suitable digital device, prompts the employee to enter 520 account custodian-identifying information in order to be able to grant such a request. Such account custodian-identifying information includes, for example, a name of the account custodian, a social security number of the account custodian, an account number, user name, and/or password of the financial account, and/or any suitable combination thereof. In various instances, the account custodian-identifying information involves multi-factor authentication where the account custodian must provide multiple identifiers to the employee. For example, an account custodian may be required to provide at least one identifier before a secret code is transmitted to a phone number or email address associated with the financial account. The account custodian, upon receipt of the secret code, provides the secret code to the employee. The employee then enters such secret code to successfully confirm the identity of the account custodian. In various instances, the secret code can be time-sensitive and expire after a pre-defined amount of time has elapsed.

In the event the employee successfully confirms the identity of the account custodian and confirms that a hold flag is associated with the particular financial account, the graphical user interface (GUI) presents a “lift hold” or “remove flag” button, or region, to the employee. Upon receiving an employee input indicative that the “lift hold” button was selected 530, a processor is to confirm 540 an identity and/or credential of the employee. For example, referring again to FIG. 2, each employee 121, 131, 141 can be associated with unique credentials 125, 135, 145, respectively, which permit access to certain information 152, 153, 154, respectively associated with the financial account 150. Such employee identity and/or credential can be confirmed through the input of an employee's unique username and/or password, identifying the digital device used to select the “lift hold” option, a biometric authentication, and/or any combinations thereof. The biometric authentication can include a fingerprint, facial recognition, voice recognition, and/or a retina scan, for example.

Upon confirmation of the employee identification and respective credentials that authorize removal of a hold, the processor is to complete the request by removing 550 the hold associated with the particular financial account. Conversely, if the employee seeking to remove the hold is not credentialed to remove the hold, the employee identity/credentials are not confirmed at 540. In such instances, the hold would not be removed and the electronic flag on the account would continue to indicate that the account contents were still held, or “frozen.”

While certain transactions originate and/or occur internally within the financial institution between various financial accounts, other transactions originate from a third party service such as a digital payment network, for example. Stated another way, certain transactions involve a financial account within the financial institution sending funds to another account in response to a transaction hosted by, or otherwise initiated on, a third party service. In such instances, the third party service is not apprised of any hold flags set with respect to a particular account. As such, transactions are able to be initiated, and the financial institution must intervene to prevent the transaction from completing when the financial account has a hold flag set. An information-sharing partnership between the financial institution and third party service can prevent such transactions from even being initiated when they involve a financial account with a hold flag set. The information-sharing partnership would necessarily involve the sharing of various account status and account identifying information.

Various aspects of the subject matter described herein are set out in the following numbered Clauses.

Clause 1—a method for authorizing a transaction hold renewal. The method including receiving a request to place a transaction hold on a financial account managed by a financial institution, updating an transaction hold status in an account information database from an inactive status to an active status in response to the received request to place the transaction hold on the financial account, and receiving, from a requesting party, a subsequent request to remove the transaction hold from the financial account. The method further including receiving, from an employee of the financial institution, an input to update the transaction hold status from the active status to the inactive status, determining, by a computer system, an identity of the employee, confirming, by the computer system, an authority of the employee to remove the transaction hold by comparing the determined employee identity to an authorized employee list stored in a bank entitlements database, and removing the transaction hold from the financial account based on the confirmed authority of the employee to remove the transaction hold.

Clause 2—the method of Clause 1, wherein the requesting party and the employee are distinct, and wherein the method further includes electronically transmitting, by a computer system, the subsequent request to remove the transaction hold from the requesting party to the employee.

Clause 3—the method of Clauses 1 or 2, further including updating the transaction hold status from the active status to the inactive status based on the confirmed authority of the employee to remove the transaction hold from the financial account.

Clause 4—the method of Clauses 1, 2, or 3, further including permitting a transaction to be completed based on an inactive hold status.

Clause 5—the method of Clause 4, further including preventing a second transaction from being completed based on the active hold status.

Clause 6—the method of Clause 5, further including preventing the second transaction from being initiated based on the active hold status.

Clause 7—the method of Clauses 1, 2, 3, 4, 5, or 6, wherein determining the identity of the employee includes identifying a device from which the input to update the transaction hold status from the active status to the inactive status is received as a registered device.

Clause 8—the method of Clauses 1, 2, 3, 4, 5, 6, or 7, wherein determining the identity of the employee includes conducting a biometric assessment of the employee.

Clause 9—the method of Clauses 1, 2, 3, 4, 5, 6, 7, or 8, wherein determining the identity of the employee includes evaluating an employee credential of the employee.

Clause 10—the method of Clauses 1, 2, 3, 4, 5, 6, 7, 8, or 9, further including receiving, from the employee of the financial institution, a second input to update the transaction hold status from the active status to the inactive status, determining, by the computer system, the identity of the employee, determining, by the computer system, the authority of the employee to remove the transaction hold by comparing the determined employee identity to the authorized employee list stored in the bank entitlements database, and maintaining a current transaction hold status based on an inability to determine that the authority of the employee grants the employee the rights to remove the transaction hold.

Clause 11—an authorization system for deactivating a transaction hold. The authorization system includes a financial account including a transaction hold associated therewith and an account database including information relating to the financial account stored therein. The information includes a status of the transaction hold, wherein the status of the transaction hold indicates whether the transaction hold is active or inactive. The transaction hold is to prevent a transaction from being completed while the transaction hold is active. The transaction hold is to permit the transaction from being completed while the transaction hold is inactive. The authorization system further includes a graphical user interface to receive a first input from a user, wherein the first input is indicative of a request to transition the transaction hold from an active transaction hold to an inactive transaction hold and a processor to communicate with the account database and the graphical user interface. The processor is to receive the first input from the graphical user interface, determine an identity of the user, confirm the determined identity of the user corresponds to an authorized user by comparing the determined employee identity to the authorized employee list stored in the bank entitlements database, and update the status of the transaction hold in the account database from the active transaction hold to the inactive transaction hold based on the confirmation that the identity of the user corresponds to an authorized user.

Clause 12—the authorization system of Clause 11, wherein the financial account is managed by a financial institution, wherein the user is an employee of the financial institution.

Clause 13—the authorization system of Clauses 11 or 12, wherein the processor is further to receive a second input from the graphical user interface. The second input is indicative of a second request to transition the transaction hold from an active transaction hold to an inactive transaction hold. The processor is further to determine a second identity of the user, analyze the determined second identity against the authorized employee list stored in the bank entitlements database, and maintain a current transaction hold status based on an inability to confirm an authority of the user.

Clause 14—the authorization system of Clauses 11, 12, or 13, wherein the processor is further to prevent the transaction from being initiated based on the transaction hold being active.

Clause 15—the authorization system of Clauses 11, 12, 13, or 14, wherein the transaction originates from a third party service outside of the financial institution.

Clause 16—the authorization system of Clause 15, wherein the third party service includes a digital payment network.

Clause 17—a method for authorizing a transaction hold renewal. The method including electronically receiving, from an employee of the financial institution, an input to update a transaction hold status from an active status to an inactive status, determining, by a computer system, an identity of the employee, and confirming, by the computer system, an authority of the employee to remove the transaction hold by comparing the determined employee identity to an authorized employee list stored in a bank entitlements database. The method further including removing, by the computer system, the transaction hold from the financial account based on the confirmed authority of the employee to remove the transaction hold and permitting, by the computer system, a transaction to be completed based on the removal of the transaction hold from the financial account.

Clause 18—the method of Clause 17, wherein determining an identity of the employee includes a multi-factor authentication process.

Clause 19—the method of Clauses 17 or 18, further including electronically receiving, from the employee of the financial institution, a second input to remove the transaction hold, determining, by the computer system, the identity of the employee, determining, by the computer system, the authority of the employee to remove the transaction hold by comparing the determined employee identity to the authorized employee list stored in the bank entitlements database, and maintaining a current transaction hold status based on an inability to determine the identity of the employee.

Clause 20—the method of Clauses 17, 18, or 19, further including electronically receiving, from the employee of the financial institution, a second input to remove the transaction hold, determining, by the computer system, the identity of the employee, determining, by the computer system, the authority of the employee to remove the transaction hold by comparing the determined employee identity to the authorized employee list stored in the bank entitlements database, and maintaining a current transaction hold status based on an inability to determine the authority of the employee to remove the transaction hold.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

In accordance with the present disclosure, the one or more processors 160 can execute various program instructions, which can be stored in a memory circuit, to implement various algorithms, or processes, associated with authenticating requests for removing a transaction hold from a financial account. Such algorithms, e.g., thresholds, limits, triggers, conditions, pauses, and/or wait time, can be adjusted based on information received from a requesting party, a user, and/or an employee of the financial institution.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T).

Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more than one” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more than one” or “at least one” and indefinite articles such as “a” or “an” (e.g., “a” and/or “an” should typically be interpreted to mean “at least one” or “one or more than one”); the same holds true for the use of definite articles used to introduce claim recitations. The singular form of “a”, “an”, and “the” include the plural references unless the context clearly dictates otherwise.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

It is worthy to note that any reference numbers included in the appended claims are used to reference exemplary embodiments/elements described in the present disclosure. Accordingly, any such reference numbers are not meant to limit the scope of the subject matter recited in the appended claims.

What is claimed is:

1. A method for authorizing a transaction hold renewal, the method comprising:
receiving a request to place a transaction hold on a financial account managed by a financial institution;
updating a transaction hold status in an account information database from an inactive status to an active status in response to the received request to place the transaction hold on the financial account;
receiving, from a requesting party, a subsequent request to remove the transaction hold from the financial account;
receiving, from an employee of the financial institution, an input to update the transaction hold status from the active status to the inactive status;
determining, by a computer system, an identity of the employee;
confirming, by the computer system, an authority of the employee to remove the transaction hold by comparing the determined employee identity to an authorized employee list stored in a bank entitlements database; and
removing the transaction hold from the financial account based on the confirmed authority of the employee to remove the transaction hold.

2. The method of claim 1, wherein the requesting party and the employee are distinct, and wherein the method further comprises electronically transmitting, by a computer system, the subsequent request to remove the transaction hold from the requesting party to the employee.

3. The method of claim 1, further comprising updating the transaction hold status from the active status to the inactive status based on the confirmed authority of the employee to remove the transaction hold from the financial account.

4. The method of claim 1, further comprising permitting a transaction to be completed based on an inactive hold status.

5. The method of claim 4, further comprising preventing a second transaction from being completed based on the active hold status.

6. The method of claim 5, further comprising preventing the second transaction from being initiated based on the active hold status.

7. The method of claim 1, wherein determining the identity of the employee comprises identifying a device from which the input to update the transaction hold status from the active status to the inactive status is received as a registered device.

8. The method of claim 1, wherein determining the identity of the employee comprises conducting a biometric assessment of the employee.

9. The method of claim 1, wherein determining the identity of the employee comprises evaluating an employee credential of the employee.

10. The method of claim 1, further comprising:
receiving, from the employee of the financial institution, a second input to update the transaction hold status from the active status to the inactive status;
determining, by the computer system, the identity of the employee;
determining, by the computer system, the authority of the employee to remove the transaction hold by comparing the determined employee identity to the authorized employee list stored in the bank entitlements database; and
maintaining a current transaction hold status based on an inability to determine that the authority of the employee grants the employee rights to remove the transaction hold.

11. An authorization system for deactivating a transaction hold, wherein the authorization system comprises:
a financial account comprising a transaction hold associated therewith;
an account database comprising information relating to the financial account stored therein, wherein the information comprises a status of the transaction hold, wherein the status of the transaction hold indicates whether the transaction hold is active or inactive, wherein the transaction hold is to prevent a transaction from being completed while the transaction hold is active, and wherein the transaction hold is to permit the transaction from being completed while the transaction hold is inactive;
a graphical user interface to receive a first input from a user, wherein the first input is indicative of a request to transition the transaction hold from an active transaction hold to an inactive transaction hold;
a processor to communicate with the account database and the graphical user interface, wherein the processor is to:
receive the first input from the graphical user interface;
determine an identity of the user;
confirm the determined identity of the user corresponds to an authorized user by comparing the determined employee identity to a authorized employee list stored in a bank entitlements database; and
update the status of the transaction hold in the account database from the active transaction hold to the inactive transaction hold based on the confirmation that the identity of the user corresponds to an authorized user.

12. The authorization system of claim 11, wherein the financial account is managed by a financial institution, wherein the user is an employee of the financial institution.

13. The authorization system of claim 11, wherein the processor is further to:
receive a second input from the graphical user interface, wherein the second input is indicative of a second request to transition the transaction hold from an active transaction hold to an inactive transaction hold;
determine a second identity of the user;
analyze the determined second identity against the authorized employee list stored in the bank entitlements database; and
maintain a current transaction hold status based on an inability to confirm an authority of the user.

14. The authorization system of claim 11, wherein the processor is further to prevent the transaction from being initiated based on the transaction hold being active.

15. The authorization system of claim 14, wherein the transaction originates from a third party service outside of a financial institution.

16. The authorization system of claim 15, wherein the third party service comprises a digital payment network.

17. A method for authorizing a transaction hold renewal, the method comprising:
electronically receiving, from an employee of a financial institution, an input to update a transaction hold status from an active status to an inactive status;
determining, by a computer system, an identity of the employee;
confirming, by the computer system, an authority of the employee to remove the transaction hold by comparing the determined employee identity to an authorized employee list stored in a bank entitlements database;
removing, by the computer system, the transaction hold from the financial account based on the confirmed authority of the employee to remove the transaction hold; and
permitting, by the computer system, a transaction to be completed based on the removal of the transaction hold from the financial account.

18. The method of claim 17, wherein determining an identity of the employee comprises a multi-factor authentication process.

19. The method of claim 17, further comprising:
electronically receiving, from the employee of the financial institution, a second input to remove the transaction hold;
determining, by the computer system, the identity of the employee;
determining, by the computer system, the authority of the employee to remove the transaction hold by comparing the determined employee identity to the authorized employee list stored in the bank entitlements database; and
maintaining a current transaction hold status based on an inability to determine the identity of the employee.

20. The method of claim 17, further comprising:
electronically receiving, from the employee of the financial institution, a second input to remove the transaction hold;
determining, by the computer system, the identity of the employee;
determining, by the computer system, the authority of the employee to remove the transaction hold by comparing the determined employee identity to the authorized employee list stored in the bank entitlements database; and
maintaining a current transaction hold status based on an inability to determine the authority of the employee to remove the transaction hold.
